(19) United States
(12) Patent Application Publication
(10) Pub. No.: US 2002/0103002 A1
(43) Pub. Date: Aug. 1, 2002

(54) Method for locating a GPS receiver in a wireless handset to minimize interference

(75) Inventor: Robert K. Tendler, Chestnut Hill, MA (US)

Correspondence Address: Robert K. Tendler, 65 Atlantic Avenue, Boston, MA, 02110, US

(73) Assignee: TENDLER CELLULAR, INC.

(21) Appl. No.: 09/774,941

(22) Filed: Jan. 31, 2001

(51) Int. Cl. H04M 1/00

(52) U.S. Cl. 455/550; 455/67.3; 455/570; 455/501; 455/296

(57) ABSTRACT

A GPS receiver is mounted within a wireless handset in which the GPS receiver is spaced from a phone motherboard carrying a transmit section, with shielding interposed between the GPS receiver and the phone motherboard for suppressing radiation which interferes with the proper operation of the GPS receiver. The result is that the GPS receiver is not mounted to the phone motherboard but rather is spaced from one side thereof, with the receiver, in one embodiment, being placed in a shielded housing so as to form a Faraday cage around the GPS receiver. In order to further minimize interference between the radiation from the transmit section of the phone motherboard and the GPS receiver, a GPS antenna is utilized which has a two or three pole filter and a low noise amplifier tuned to reject the interfering radiation from the phone motherboard and in one embodiment is provided with a semi-rigid coaxial cable to prevent interfering radiation from entering the GPS receiver through the coaxial cable.

### FIELD OF INVENTION

This invention relates to the provision of a GPS receiver within a wireless handset and more particularly to a method for minimizing the interfering radiation from the phone motherboard from affecting the GPS receiver.

### BACKGROUND OF THE INVENTION

GPS receivers have long been known to deliver location information through the receipt of signals from some twenty-six GPS satellites which orbit the earth. As originally designed, the GPS system utilizes a 40 watt spread spectrum transmitter which results in radiation at the surface of the earth, which is −150 dB down. It is noted that the absolute noise floor level is −160 dB. Thus prior to correlation of the GPS signals, meaning that the correlators have not found and intergrated the spread spectrum signals, it is only with difficulty that the relatively weak signals are in fact detected at all.

It is noted that the center frequency of GPS is 1.17542 GHz which is suseptible to a number of interfering radiation sources. Not only is the GPS receiver subject to interference from INMARSAT radiation at 1.6 GHz, TV channels 26 and 27 have harmonics which interfere with the receipt of the GPS signals. Additionally, some airport radars interfere with GPS reception. Moreover, virtual components of the 9 GHz microwave communication links between buildings also interfere with the GPS center frequency.

The situation of the interfering sources as noted above makes receipt of the GPS signal sometimes impossible in urban environments or close to interfering radiation sources.

Added to this is the interference from the wireless phone itself in terms of the harmonics of the frequencies which are utilized. This is exceedingly problematic when considering the cellular phone band of 800 MHz. It is noted that the center frequency for the control channel of both the A and B sides of the cellular system is 832 MHz. Doubled, we have 1664 MHz. As is common with most inexpensive wireless phones, there is a 90 MHz down convert from the transmit frequencies to arrive at the receive frequencies. Subtracting 90 MHz form 1664 MHz yields 1574 MHz, clearly an interfering signal for GPS at 1575 MHz which in some instances prevents the receipt of GPS signals at all.

While it is true that radiation falls off with the square of the distance, when the transmit section of the wireless phone is on the same printed circuit board which mounts the GPS receiver, there is an intolerable interference problem because the above noted components are fed directly to the GPS receiver. Thus even though current GPS receivers are filtered heavily, in most instances with the GPS receiver directly on the phone motherboard, receipt of the GPS signals in a reliable fashion is unlikely.

It is of course important to be able to co-locate a GPS receiver and the motherboard within a wireless handset, if for no other reason than to be able to report in an emergency situation the location of the wireless transceiver. Thus wireless phones having a GPS receiver or front end, while solving the location problem for E-911 service, are in general not reliable enough to be utilized in this type of emergency situation. The result of the interference, if not complete blockage of the GPS signals, is that the time to acquire the satellites, called time to first time fix, is exceedingly long.

For instance, a time to first fix, which may be on the order of one second, may be extended to forty to sixty seconds in the presence of wireless phone induced interference.

Not only are the emergency services affected, the utilization of the wireless handset in providing the basis for location-based services is also likewise impacted. Thus for instance, dispatching a tow truck to the immediate area of the wireless phone is impeded, as are multiple other applications, for instance, turn-by-turn directions, location of packages, or any system which utilizes the wireless network as a communication link to the report location.

### SUMMARY OF THE INVENTION

Rather than locating the GPS receiver directly on the phone motherboard, in the subject invention, the GPS receiver is spaced from the phone motherboard, with shielding being interposed between the printed circuit board or support for the GPS receiver and the phone motherboard.

It has unexpectedly been found that the interposition of for instance of a 16th of an inch zinc shield between the phone motherboard and the GPS-receiver results in the sinking or elimination of a good portion of the interfering radiation. When this zinc shield is mechanically grounded to the ground plane for the phone motherboard and also to the GPS-receiver ground, even further elimination of interfering signals becomes possible.

Optionally, the entire GPS-receiver may be placed in a Faraday shield environment in which the housing in which the GPS-receiver is placed is provided with internal shielding, again electrically and mechanically coupled to the shielding interposed between the GPS-receiver and the phone motherboard and in fact electrically and mechanically connected to the ground plane of the phone motherboard.

Additionally, it has been found that some of the radiation from the transmit section of the wireless phone is introduced into the GPS-receiver through the GPS antenna. In order to eliminate or at least reduce this interference path, the GPS antenna has associated with it a two-pole or three pole relatively sharp filter centered around 1.57542 GHz, with the antenna being supplied with a low noise amplifier. Shielding is supplied around the center post of the GPS patch antenna normally utilized and also completely shields the low noise amplifier and filter. Furthermore, it has been found that an interference path exists between the GPS antenna and the GPS receiver due to the marginally effective coaxial cable used for this purpose. For eliminating this source of interference, a high quality coaxial cable is utilized between the GPS antenna and the GPS receiver. In one embodiment, the coax is a so-called semi-rigid coax which involves the utilization of a flexible copper tube surrounding the center conductor, with the flexible copper providing the maximum shielding and grounding so as to eliminate the interference path.

The result of utilizing one or more of the above-mentioned interference reducing measures is that one can successfully locate a GPS receiver at a wireless handset through the utilization of interference reducing techniques involving extremely heavy shielding between the phone motherboard and the GPS receiver. Thus while it may not be possible to completely eliminate interference due to the fact that there is LCD display and keys which are attached to the phone motherboard and out of which radiation eminates, it is nonetheless possible to achieve receipt of extremely weak GPS signals in a robust fashion despite the interfering signal situation, especially with respect to the cellular frequencies.

In summary, a GPS receiver is mounted within a wireless handset in which the GPS receiver is spaced from a phone motherboard carrying a transmit section, with shielding interposed between the GPS receiver and the phone motherboard for suppressing radiation which interferes with the proper operation of the GPS receiver. The result is that the GPS receiver is not mounted to the phone motherboard but rather is spaced to one side thereof, with the receiver, in one embodiment, being placed in a shielded housing so as to form a Faraday cage around the GPS receiver. In order to further minimize interference between the radiation from the transmit section of the phone motherboard and the GPS receiver, a GPS antenna is utilized which has a two or three pole filter and a low noise amplifier tuned to reject the interfering radiation from the phone motherboard and in one embodiment is provided with a semi-rigid coaxial cable to prevent interfering radiation from entering the GPS receiver through the coaxial cable.

### BRIEF DESCRIPTIONS OF THE DRAWINGS

These and other features of the subject invention will be better understood with conjunction with the Detailed Description in connection with the Drawings of which:

FIG. 1 is a diagrammatic illustration of a wireless transceiver in which a GPS receiver is mounted at the wireless transceiver, with the transceiver also carrying a GPS antenna, in one embodiment at the top thereof;

FIG. 2 is a side view of a prior art method for mounting a GPS receiver to the phone motherboard in an effort to achieve complete integration, showing an interference path from the transmit section of the transceiver through the printed circuit board to the GPS receiver which causes enough interference to prevent the GPS receiver from locking onto to the GPS satellites; and,

FIG. 3 is a diagrammatic illustration of the subject system in which the GPS receiver is spaced from the phone motherboard and is provided with a shield between the GPS receiver and the phone motherboard, also illustrating optional Faraday cage shielding for the GPS receiver as well as the utilization of semi-rigid coax to connect the GPS antenna to the GPS receiver, all of which contributing to eliminating interference from the wireless handset.

### DETAILED DESCRIPTION

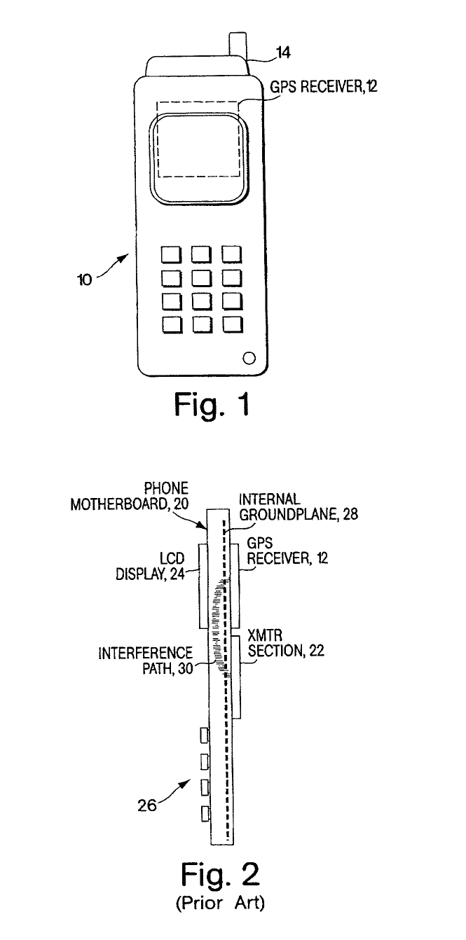

As illustrated in FIG. 1 a wireless handset 10 is shown in which a GPS receiver 12 is housed within a handset. A GPS antenna 14 is carried by the handset, preferably at the top thereof. It is also possible that the GPS antenna maybe on a hinged support which overlies the front of the phone or can be hinged from the back of the phone. Additionally, the GPS antenna may be mounted to the back of the phone itself.

As mentioned hereinabove, a situation occurs in the co-location of the GPS receiver and the phone motherboard within the wireless handset. Interference, as illustrated in FIG. 2 results when GPS receiver 12 is mounted to the phone motherboard 20, with an adjacent transmit section 22 also mounted to the phone motherboard. Also mounted to the phone motherboard is an LCD display 24 and keys generally indicated at 26 in order to be able to dial the wireless phone.

In general, each phone motherboard has one or more internal ground planes, here illustrated at 28, which serve to minimize interference between the components on the phone motherboard. Moreover, shielding maybe applied to both the transmit and receive sections of the transceiver mounted to the phone motherboard, again to prevent the interference between these sections.

However, while the above shielding is effective in most cases to prevent the receive and transmit section from interfering with each other, there is an interference path through the printed circuit board here illustrated at 30, in which the above-noted interfering harmonics are transmitted from the transmit section 22 to the GPS receiver 12 through the phone motherboard itself. The result as stated above, is that the GPS receiver may find itself unable to lock onto the GPS satellites. It is for this reason that those handsets fail which attempt to mount the GPS receiver directly to the phone motherboard in an effort for tight integration.

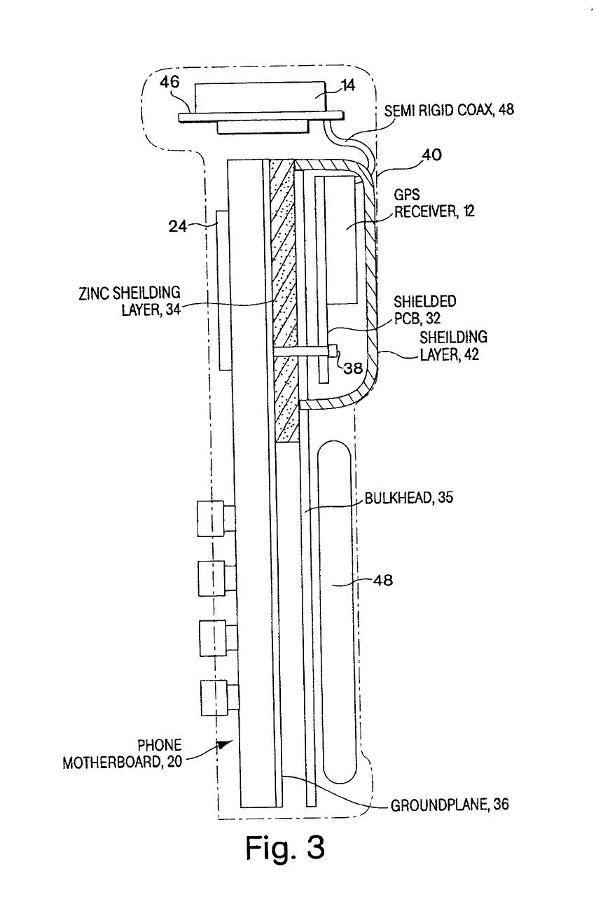

In contra-distinction to the mounting of the GPS receiver to the phone motherboard, in the subject invention, as illustrated in FIG. 3, GPS receiver 12 is mounted to a shielded printed circuit board 32 which is spaced from the phone motherboard 20 with a heavy shielding layer 34 interposed between the PCB 32 and motherboard 20.

In one embodiment, the shielding is made of a spray coated zinc to a thickness of 1/16th of an inch on a bulkhead 35, it being understood that zinc has some of the most superior shielding qualities known.

In one embodiment, shielding 34 is mechanically and electrically connected to the ground plane 36 of the phone motherboard through a mechanical screw connection 38. This mechanical connection can also ground the ground plane of the PCB 32 to shielding 34 and also to ground plane 36.

Optionally and in one embodiment, a housing or pod 40 for the GPS receiver can be provided with internally carried shielding 42 which connects electrically to shielding 34 and preferably around its periphery to shielding 34 to provide a Faraday cage in which the GPS receiver is housed.

In a further attempt to minimize interference from the phone motherboard, in one embodiment, GPS antenna 12 is provided with a filtering system and a low noise amplifier housed at 44 which housing is electrically connected around its periphery to ground plane 46 of the GPS antenna. This eliminates a portion of the interfering radiation from the phone motherboard.

Also, in order to more thoroughly shield the GPS receiver from the interfering radiation a semi-rigid coaxial cable 48 connects the GPS antenna 14 to GPS receiver 12.

As is usual a battery 48 is utilized to power the wireless phone. It has been found that the battery in and of itself does not operate as a sufficient sink to eliminate the interfering signals mentioned above.

What has therefore been provided is a system for minimizing the interference between sources on the phone motherboard and the on-board GPS receiver through the spacing of the GPS receiver from the phone motherboard and by providing shielding there between. Optional Faraday cage technology and specialized GPS antennas along with specialized coax also contribute to minimizing the severe interference from the wireless phone itself.

The result is that while in the past it has been relatively impossible to provide a wireless phone with a working and robust GPS receiving system, in the subject invention, removing the GPS receiver from the phone motherboard and shielding it results in significant reduction of the phone motherboard interference, which results in a robust system for the receipt of GPS signals.

Having now described a few embodiments of the invention, and some modifications and variations thereto, it should be apparent to those skilled in the art that the foregoing is merely illustrative and not limiting, having been presented by the way of example only. Numerous modifications and other embodiments are within the scope of one of ordinary skill in the art and are contemplated as falling within the scope of the invention as limited only by the appended claims and equivalents thereto.

What is claimed is:

1. A method of minimizing interference from wireless handset components which interferes with the receipt of GPS signals by a GPS receiver located at the handset in which the wireless phone has a motherboard, comprising the steps of:
spacing the GPS receiver from the phone motherboard; and,
providing shielding between the GPS receiver and the motherboard.

2. The method of claim 1, wherein the motherboard has ground plane and further including the step of electrically connecting the shielding to the ground plane of the motherboard.

3. The method of claim 2, and further including the step of mechanically connecting the shielding to the ground plane of the motherboard.

4. The method of claim 1, wherein the shielding includes zinc.

5. The method of claim 1, and further including the step of providing a physical barrier between the GPS receiver and the motherboard, the barrier having an electrically conductive coating thereon.

6. The method of claim 5, wherein the coating includes zinc.

7. The method of claim 2, wherein the GPS receiver has a system ground and further including the step of electrically connecting the shielding to the system ground of the GPS receiver.

8. The method of claim 1, wherein the handset has a housing and wherein the housing includes a pod for carrying the GPS receiver and further including the steps of providing the walls of the pod with shielding.

9. The method of claim 8, wherein the pod-carried shielding forms a Faraday cage about the GPS receiver.

10. The method of claim 1, wherein the wireless handset carries a patch type GPS antenna with a ground plane and a GPS output connector and further including the step of providing shielding around the output connector.

11. The method of claim 10, and further including providing heavily shielded coaxial cable between the output connector and the GPS receiver.

12. The method of claim 11, wherein the heavy shielding is provided by semi-rigid coaxial cable.

13. The method of claim 10, wherein the GPS antenna includes a filter coupled to the output connection to filter out components to either side of the GPS antenna frequency.

14. The method of claim 15, wherein the GPS antenna includes a low noise amplifier for amplifying the signal from the GPS antenna to compensate for losses due to the insertion of the filter.

15. A system for providing a GPS receiver in a wireless handset such that interference between the components of the handset and the GPS receiver is minimized to a sufficient extent to permit robust receipt of signals by the GPS receiver from GPS satellites, comprising:
a wireless handset housing;
a phone motherboard located within said housing;
a GPS receiver spaced from one side of said phone motherboard; and,
shielding interposed between said GPS receiver and said motherboard.

16. The system of claim 15, wherein said housing includes a bulkhead between said phone motherboard and said GPS receiver and wherein said bulkhead has said shielding affixed thereto.

17. The system of claim 16, wherein said shielding is in the form of a conductive layer on said bulkhead.

18. The system of claim 15, wherein said shielding includes zinc.

19. The system of claim 15, wherein said phone motherboard has a ground layer and wherein said shielding is electrically connected to said ground layer.

20. The system of claim 15, wherein said GPS receiver has a system ground and wherein said shielding is electrically connected to said system ground.
